(19) United States
(12) Patent Application Publication
(10) Pub. No.: US 2018/0020238 A1
(43) Pub. Date: Jan. 18, 2018

(54) METHOD AND APPARATUS FOR VIDEO CODING

(71) Applicant: MEDIATEK INC., Hsin-Chu (TW)

(72) Inventors: Shan Liu, San Jose, CA (US); Xiaozhong Xu, State College, PA (US); Jungsun Kim, San Jose, CA (US)

(73) Assignee: MEDIATEK INC., Hsin-Chu (TW)

(21) Appl. No.: 15/649,089

(22) Filed: Jul. 13, 2017

Related U.S. Application Data
(60) Provisional application No. 62/362,613, filed on Jul. 15, 2016.
(60) Provisional application No. 62/403,734, filed on Oct. 4, 2016.

(51) Int. Cl. H04N 19/597; H04N 19/55; H04N 19/184; H04N 19/182; H04N 19/18; H04N 19/176; H04N 19/167; H04N 19/124; H04N 19/119; H04N 19/70; H04N 19/107

(52) U.S. Cl. CPC H04N 19/597; H04N 19/70; H04N 19/55; H04N 19/184; H04N 19/182; H04N 19/107; H04N 19/176; H04N 19/167; H04N 19/124; H04N 19/119; H04N 19/18

(57) ABSTRACT

Aspects of the disclosure provide an apparatus having a processing circuit. The processing circuit is configured to receive images in a rectangular plane that are projected from images of a sphere surface according to a projection from the sphere surface to the rectangular plane, and encode/decode the images in the rectangular plane based on image characteristics of the rectangular plane that are associated with the projection.

### INCORPORATION BY REFERENCE

This present disclosure claims the benefit of U.S. Provisional Application No. 62/362,613, “Methods and apparatus for 360 degree video coding” filed on Jul. 15, 2016, and U.S. Provisional Application No. 62/403,734, “Methods and apparatus for omni-directional video and image coding” filed on Oct. 4, 2016, which are incorporated herein by reference in their entirety.

### TECHNICAL FIELD

The present disclosure describes embodiments generally related to video coding method and apparatus, and more particularly related to omni-directional video coding technology.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior an against the present disclosure.

Three-dimensional environments can be rendered to provide special user experience. For example, in a virtual reality application, computer technologies create realistic images, sounds and other sensations that replicate a real environment or create an imaginary setting, thus a user can have a simulated experience of a physical presence in a three-dimensional environment.

### SUMMARY

Aspects of the disclosure provide an apparatus having a processing circuit. The processing circuit is configured to receive images in a rectangular plane that are projected from images of a sphere surface according to a projection from the sphere surface to the rectangular plane, and encode/decode the images in the rectangular plane based on image characteristics of the rectangular plane that are associated with the projection.

According to an aspect of the disclosure, the processing circuit is configured to receive the images in the rectangular plane that are projected from the images of the sphere surface according to an equirectangular projection (ERP), and adjust one or more encoding/decoding parameters as a function of latitudes of the rectangular plane. In an embodiment, the processing circuit is configured to adjust bit allocation for regions in the rectangular plane as a function of the latitudes of the regions. In another embodiment, the processing circuit is configured to adjust a partition size for regions in the rectangular plane as a function of the latitudes of the regions. In another embodiment, the processing circuit is configured to adjust a sampling rate for regions in the rectangular plane as a function of the latitudes of the regions. In another embodiment, the processing circuit is configured to adjust a quantization parameter for regions in the rectangular plane as a function of the latitudes of the regions. In another embodiment, the processing circuit is configured to calculate a reference for a coding unit during an inter prediction based on a latitude of the coding unit and a motion vector.

According to another aspect of the disclosure, the processing circuit is configured to receive the images in the rectangular plane that are projected from the images of the sphere surface according to a platonic solid projection from the sphere surface to a plurality of non dummy faces re-arranged in the rectangular plane and encode/decode the images in the rectangular plane based on image characteristics of faces in the rectangular plane. In an embodiment, the processing circuit is configured to scan blocks face by face during encoding. In another example, the processing circuit is configured to order the faces according to spatial relationship of the faces. In another example, the processing circuit is configured to skip dummy faces during encoding/decoding.

According to another aspect of the disclosure, the processing circuit is configured to receive the images in the rectangular plane that are projected from the images of the sphere surface according to a projection that causes deformation as a function of locations and perform deformed motion compensation during an inter prediction. In an embodiment, the processing circuit is configured to selectively perform motion compensation without deformation and the deformed motion compensation based on a merge index in a merge mode. In another embodiment, the processing circuit is configured to perform the deformed motion compensation at one of a sequence level, a picture level, a slice level and a block level based on a flag.

Aspects of the disclosure provide a method for image processing. The method includes receiving, by a processing circuit, images in a rectangular plane that are projected from images of a sphere surface according to a projection from the sphere surface to the rectangular plane and encoding/decoding the images in the rectangular plane based on image characteristics of the rectangular plane that are associated with the projection.

### BRIEF DESCRIPTION OF THE DRAWINGS

Various embodiments of this disclosure that are proposed as examples will be described in detail with reference to the following figures, wherein like numerals reference like elements, and wherein:

FIG. 1 shows a block diagram of a media system 100 according to an embodiment of the disclosure;

FIG. 2 shows a plot 200 illustrating equirectangular projection (ERP) according to an embodiment of the disclosure;

FIG. 3 shows a plot 300 illustrating an example of platonic solid projection according to an embodiment of the disclosure;

FIG. 4 shows a block diagram of an encoder 430 according to embodiments of the disclosure;

FIG. 5 shows a flow chart outlining a process example 500 according to an embodiment of the disclosure;

FIG. 6 shows as flow chart outlining a process example 600 according to an embodiment of the disclosure;

FIG. 7 shows partition examples according to an embodiment of the disclosure;

FIG. 8 shows a plot 800 illustrating reference calculation for ERP projection according to an embodiment of the disclosure;

FIG. 9 shows a flow chart outlining a process example 900 according to an embodiment of the disclosure;

FIG. 10 shows a plot 1000 illustrating block scan examples according to an embodiment of the disclosure; and

FIG. 11 shows a plot 1100 illustrating face scan examples according to an embodiment of the disclosure.

### DETAILED DESCRIPTION OF EMBODIMENTS

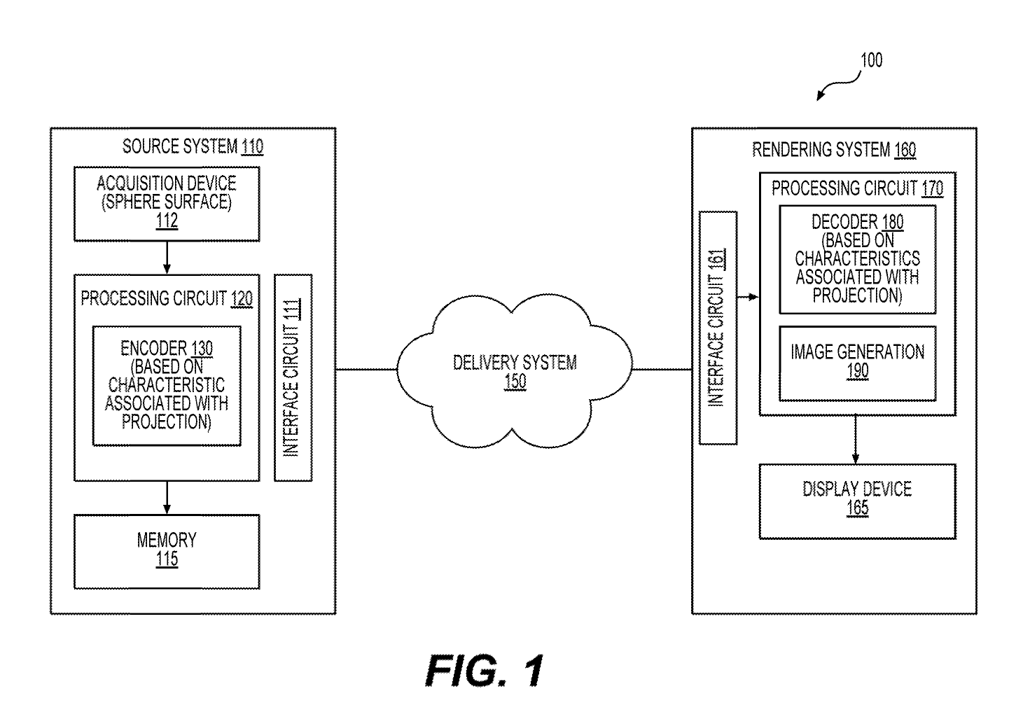

FIG. 1 shows a block diagram of a media system 100 according to an embodiment of the disclosure. The media system 100 includes a source system 110, a delivery system 150 and a rendering system 160 coupled together. The source system 110 is configured to acquire media data for three-dimensional environments and suitably encapsulate the media data. The delivery system 150 is configured to deliver the encapsulated media data from the source system 110 to the rendering system 160. The rendering system 160 is configured to render simulated three-dimensional environments according to the media data. According to an aspect of the disclosure, the media system 100 is configured to acquire visual data of a sphere surface, project the visual data of the sphere surface onto a two-dimension (2D) rectangular plane as 2D images, and then encode/decode the 2D images based on image characteristics associated with the projection.

The source system 110 can be implemented using any suitable technology. In an example, components of the source system 110 are assembled in a device package. In another example, the source system 110 is a distributed system, components of the source system 110 can be arranged at different locations, and are suitable coupled together for example by wire connections and/or wireless connections.

In the FIG. 1 example, the source system 110 includes an acquisition device 112, a processing circuit 120, a memory 115, and an interface circuit 111 coupled together.

The acquisition device 112 is configured to acquire various media data, such as images, sound, and the like of three-dimensional environments. The acquisition device 112 can have any suitable settings. In an example, the acquisition device 112 includes a camera rig (not shown) with multiple cameras, such as an imaging system with two fisheye cameras, a tetrahedral imaging system with four cameras, a cubic imaging system with six cameras, an octahedral imaging system with eight cameras, an icosahedral imaging system with twenty cameras, and the like, configured to take Images of various directions in a surrounding space.

In an embodiment, the images taken by the cameras are overlapping, and can be stitched to provide a larger coverage of the surrounding space than a single camera. In an example, the images taken by the cameras can provide omnidirectional coverage(e.g., 360° sphere coverage of the whole surrounding space). It is noted that the images taken by the cameras can provide less than 360° sphere coverage of the surrounding space.

The media data acquired by the acquisition device 112 can be suitably stored or buffered, for example in the memory 115. The processing circuit 120 can access the memory 115, process the media data, and encapsulate the media data in suitable format. The encapsulated media data is then suitably stored or buffered, for example in the memory 115.

In an embodiment, the processing circuit 120 includes an audio processing path configured to process audio data, and includes an image/video processing path configured to process image/video data. The processing circuit 120 then encapsulates the audio, image and video data with metadata according to a suitable format.

In an example, on the image/video processing path, the processing circuit 120 can stitch images taken from different cameras together to form a stitched image, such as an omnidirectional image (sphere surface image), and the like. Then, the processing circuit 120 can project the omnidirectional image (for the sphere surface) to suitable two-dimension (2D) plane (e.g., rectangular plane) to convert the omnidirectional image to 2D images that can be encoded using 2D encoding techniques. Then the processing circuit 120 can suitably encode the image and/or a stream of images.

According to an aspect of the disclosure, the processing circuit 120 can project the omnidirectional images of the sphere surface to the 2D images on the rectangular plane according to different projection techniques, and the different projection techniques cause the 2D images of the rectangular plane to have different image characteristics that are associated with the projection techniques. The image characteristics can be used to improve coding efficiency.

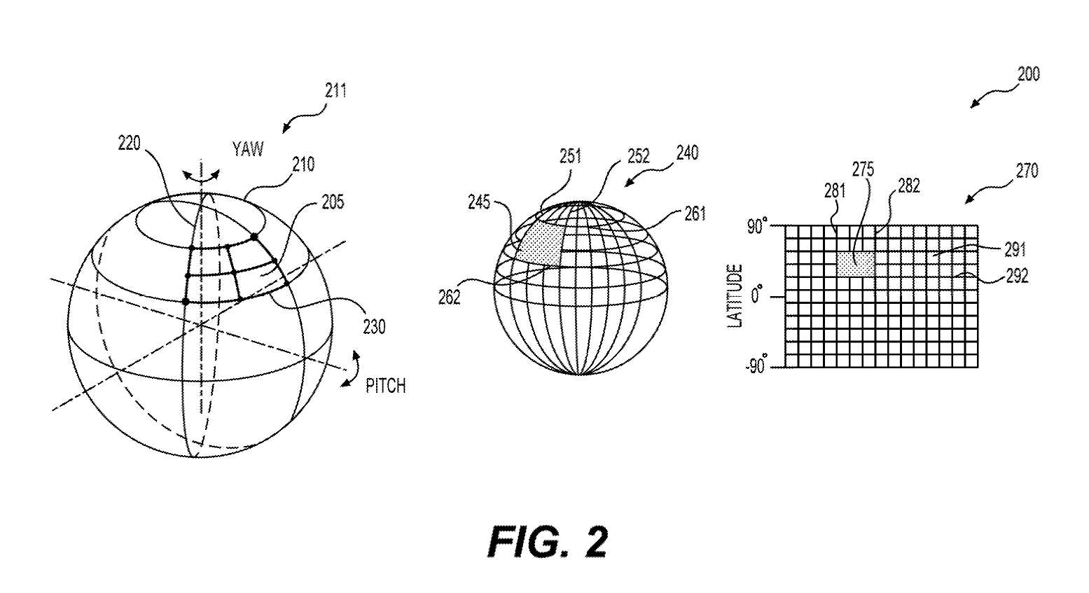

In an embodiment, the processing circuit 120 can project an omnidirectional image to a 2D image using equirectangular projection (ERP). The ERP projection projects a sphere surface, such as omnidirectional image, to a rectangular plane, such as a 2D image, in a similar manner as projecting earth surface to a map. In an example, the sphere surface (e.g., earth surface) uses spherical coordinate system of yaw (e.g., longitude) and pitch (e.g., latitude) to locate positions on the sphere surface. During the projection, the yaw circles are transformed to the vertical lines and the pitch circles are transformed to the horizontal lines, the yaw circles and the pitch circles are orthogonal in the spherical coordinate system, and the vertical lines and the horizontal lines are orthogonal in the rectangular plane. An example of ERP projection is shown in FIG. 2 and will be described with reference to FIG. 2.

In the embodiment of RP projection, patterns are deformed (e.g., stretched) in the horizontal direction (along the latitude, direction) during ERP projection and are deformed with different degrees based on the latitudes. For example, patterns are stretched with a smaller ratio when the patterns are near vertical center (e.g., corresponding to equator), patterns are stretched with a larger ratio when the patterns are away from the vertical center (e.g., closer to poles). Thus, in an example, the 2D image of the ERP projection has an image characteristic that varies with the latitude. For example, the 2D image of the ERP projection includes more image information (e.g., spatial frequency spectrum is higher, information density is higher) at regions near the vertical center (e.g., at equator) and includes less visual information (e.g., spatial frequency spectrum is lower, information density is lower) at regions away from the vertical center (e.g., at poles).

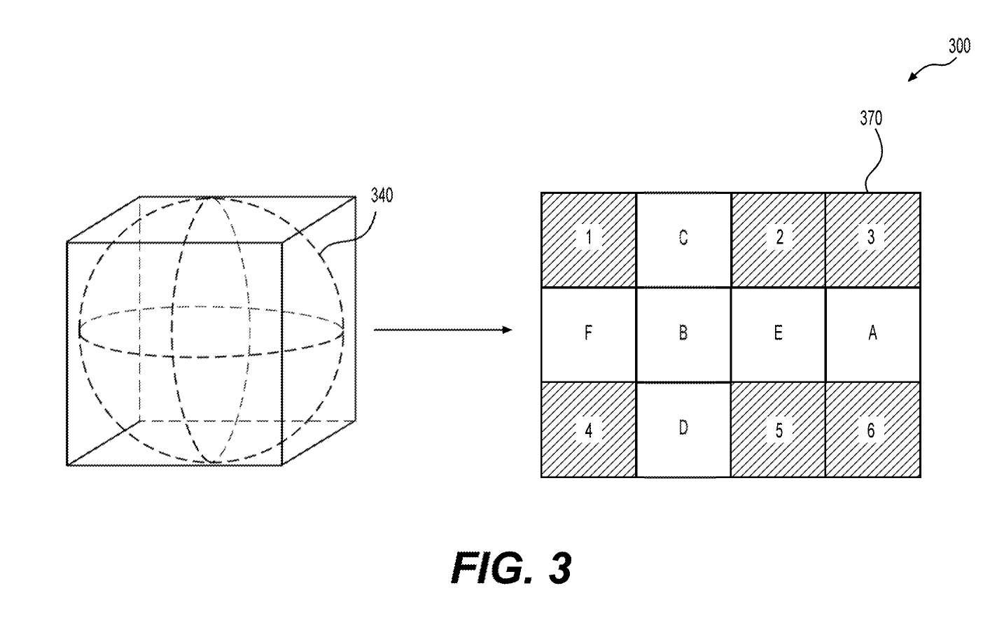

In another embodiment, the processing circuit 120 can project the omnidirectional image of the sphere surface to faces of platonic solid, such as tetrahedron, cube, octahedron, icosahedron, and the like. The projected faces can be respectively rearranged, such as rotated, relocated to form a 2D image in a rectangular plane. The 2D images are then encoded. In the embodiment of projection from the omnidirectional image of the sphere surface to faces of platonic solid, patterns may be also deformed (e.g., stretched) at different locations during such projection and are deformed with different degrees based on parameters corresponding to the locations. An example of platonic solid projection is shown in FIG. 3, and will be described with reference to FIG. 3.

In the embodiment of platonic solid projection, in an example, dummy faces are added, and the dummy faces have no or little image information. Further, in an example, because of the re-arrangement of faces during projection, neighboring faces may or may not have spatial relationship. Thus, in an example, the 2D image of the platonic solid projection has image characteristics associated with the platonic solid projection.

It is noted that, in an embodiment, the projection operation is performed by components other than the processing circuit 120. In an example, images taken from the different cameras are arranged in a rectangular plane to form a 2D image.

According to an aspect of the disclosure, the image characteristics associated with the projection techniques can be used to improve, for example, image coding efficiency, thus images can be encoded decoded using less time, the encoded image data can be stored by the media system 100 with less memory, and can be transmitted in the media system 100 in less time using less transmission resource.

In the FIG. 1 example, the processing circuit 120 includes an encoder 130 configured to encode 2D images based on image characteristics associated with a projection that projects images of a sphere surface to a rectangular plane to form the 2D images.

In an embodiment, the images of the sphere surface are projected to the rectangular plane according to, for example, the ERP projection, and such projection can cause shape change (deformation) as a function of locations. Accordingly, certain image parameters, such as image information, frequency spectrum, and the like vary with location parameters of the rectangular plane (e.g., latitudes). The encoder 130 adjusts one or more encoding/decoding parameters as a function of location parameters of the rectangular plane (e.g., latitudes) to improve coding efficiency.

In an example, the encoder 130 is configured to partition the 2D image into sub-images, such as coding units (CUs), coding tree units (CTUs), and the like for respective processing, and the encoder 130 is configured to adjust a partition size for regions in the rectangular plane as a function of the latitudes of the regions. For example, the encoder 130 is configured to use a smaller horizontal partition size for regions near vertical center, and use larger horizontal partition size for regions away from the vertical center. In another example, the encoder 130 is configured to adjust a sampling rate during partition. For example, the encoder 130 is configured to use a smaller down-sampling rate (or no down-sampling) for regions near vertical center, and use a larger clown-sampling rate for regions away from the vertical center during partition.

In another example, the encoder 130 is configured to adjust hit allocation for regions in the rectangular plane as a function of the latitudes of the regions. In an example, the encoder 130 is configured to allocate more bits to regions near vertical center and allocate fewer bits to regions away from the vertical center.

In another example, the encoder 130 is configured to adjust a quantization parameter for regions in the rectangular plane as a function of the latitudes of the regions. For example, the encoder 130 is configured to use a relatively small quantization parameter for regions near vertical center and use a relatively large quantization parameter for regions away from vertical center.

In another example, the encoder 130 is configured to perform reference calculation for a pixel during inter prediction based on a latitude of the pixel and a motion vector.

In another embodiment, the images of the sphere surface are projected to the rectangular plane according to the platonic solid projection. Accordingly, certain image characteristics, such as spatial relationship, dummy faces, deformation corresponding to different locations, and the like are associated with the platonic solid projection. The encoder 130 performs encoding based on the image characteristics that are associated with the platonic solid projection.

In an example, the encoder 130 determines a scan order based on the image characteristics. For example, the encoder 130 determines to scan blocks face by face during encoding, thus blocks within a face are scanned before scanning blocks in other faces in an example. In an example, a dummy face can be scanned and encoded with high coding efficiency.

Further, the encoder 130 determines the scan order of the faces according to spatial relationship of the faces. Thus, in an example, faces that have dose spatial relationship (e.g., neighboring in the sphere surface) are scanned in sequence in order to improve coding efficiency.

In another example, when the positions of the dummy faces are known to both the source system 110 and the rendering system 160, the encoder 130 can skip the dummy faces.

In an embodiment, the processing circuit 120 is implemented using one or more processors, and the one or more processors are configured to execute software instructions to perform media data processing. In another embodiment, the processing circuit 120 is implemented using integrated circuits.

In the FIG. 1 example, the encoded media data is encapsulated and provided to the delivery system 150 via the interface circuit 111. The delivery system 150 is configured to suitably provide the media data to client devices, such as the rendering system 160. In an embodiment, the delivery system 150 includes servers, storage devices, network devices and the like. The components of the delivery system 150 are suitably coupled together via wired and/or wireless connections. The delivery system 150 is suitably coupled with the source system 110 and the rendering system 160 via wired and/or wireless connections or is configured suitably to deliver data between the source system 110 and the rendering system 160 via any other suitable carrier or media.

The rendering system 160 can be implemented using any suitable technology. In an example, components of the rendering system 160 are assembled in a device package. In another example, the rendering system 160 is a distributed system, components of the source system 110 can be located at different locations, and are suitable coupled together by wire connections and/or wireless connections.

In the FIG. 1 example, the rendering system 160 includes an interface circuit 161, a processing circuit 170 and a display device 165 coupled together. The interface circuit 161 is configured to suitably receive a data stream corresponding to encapsulated media data via any suitable communication protocol.

The processing circuit 170 is configured to process the media data and generate images for the display device 165 to present to one or more users. The display device 165 can be any suitable display, such as a television, a smart phone, a wearable display, a head-mounted device, and the like.

In the FIG. 1 example, the processing circuit 170 includes a decoder 180 that is configured to receive encoded visual data, and decode visual data based on image characteristics associated with projection techniques. In an embodiment, the received encoded visual data is indicative of the projection techniques, or the image characteristics associated with the projection techniques, thus the decoder 180 can decode the visual data accordingly. In another example, the decoder 180 knows the projection technique that is used by the source system 110 (e.g., via an agreement, pre-setting), and then decodes the visual data according to image characteristics associated with the projection technique.

In an embodiment, the processing circuit 170 includes an image generation module 190 that is configured to generate one or more images of region of interest based on the media data. In an embodiment, the processing circuit 170 is configured to request/receive suitable media data, such as a specific track, a media data for a section of a rectangular plane, media data from a specific camera, and the like from the delivery system 150 via the interface circuit 161. Based on the decoded media data, the processing circuit 170 generates images to present to the one or more users.

In an example, the processing circuit 170 includes the decoder 180 and an image generation module 190. The image generation module 190 is configured to generate images of the region of interests. The decoder 180 and the image generation module 190 can be implemented as processors executing software instructions and can be implemented as integrated circuits.

In an embodiment, the processing circuit 170 is implemented using one or more processors, and the one or more processors are configured to execute software instructions to perform media data processing. In another embodiment, the processing circuit 170 is implemented using integrated circuits.

FIG. 2 shows a plot 200 illustrating ERP projection according to an embodiment of the disclosure. The plot 200 shows a sphere 211 with a sphere surface 210. The sphere surface 210 (e.g., earth surface) uses spherical coordinate system of yaw (e.g., longitude direction) and pitch (e.g., latitude direction). In the FIG. 2 example, boundaries of a region 205 on the sphere surface 210 are formed by yaw circles 220 (e.g., longitude lines) and pitch circles 230 (e.g., latitude lines).

Further, FIG. 2 shows an ERP projection from a sphere surface 240 to a rectangular plane 270. In the example, the sphere surface 240 uses a spherical coordinate system of yaw and pitch. In the example, the sphere surface 240 is referenced with yaw circles (e.g., yaw circle 251, yaw circle 252), and pitch circles (e.g., pitch circle 261, pitch circle 262). The rectangular plane 270 uses XY coordinate system, and is referenced with vertical lines and horizontal lines. In the FIG. 2 example, X-axis corresponds to longitude and Y-axis corresponds to latitude.

The ERP projection projects a sphere surface to a rectangular plane in a similar manner as projecting earth surface to a map. During the projection, the yaw circles are transformed to the vertical lines and the pitch circles are transformed to the horizontal lines, the yaw circles and the pitch circles are orthogonal in the spherical coordinate system, and the vertical lines and the horizontal lines are orthogonal in the XY coordinate system.

In the FIG. 2 example, a region of interests 245 on the sphere surface 240 is projected to a region of interests 275 on the rectangular plane 270. In the FIG. 2 example, the boundaries of the region of interests 245 on the sphere surface 240 are the yaw circles 251-252 and the pitch circles 261-262. The yaw circles 251-252 are projected to the rectangular plane 270 as the vertical lines 281-282, and the pitch circles 261-262 are projected to the rectangular plane 270 as the horizontal lines 291-292.

FIG. 3 shows a plot 300 illustrating an example of platonic solid projection according to an embodiment of the disclosure. In the FIG. 3 example, a sphere surface 340 is projected to faces (e.g., A-E) of a cube. The faces of the cube are arranged in a rectangular plane, and dummy faces 1-6 are added in the rectangular plane as shown in FIG. 3.

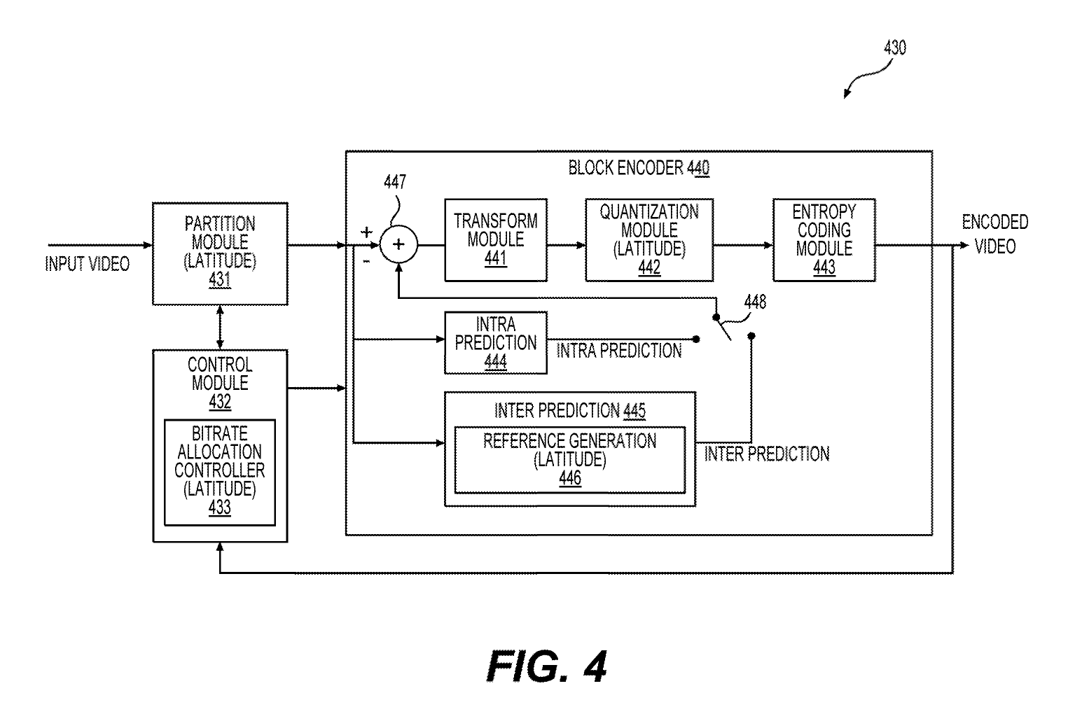

FIG. 4 shows a diagram of an encoder 430 according to an embodiment of the disclosure. The encoder 430 is configured to receive input video, such as a sequence of image frames, encode the video, and output coded video. In an example, the encoder 430 is used in the place of the encoding circuit 130 in the FIG. 1 example to encode 2D images that are projected from a sphere surface to a rectangular plane according to ERP projection, and one or more components in the encoder 430 are configured to adjust parameters for operation based on latitudes.

In the FIG. 4 example, the encoder 430 includes a partition module 431, a control module 432, and a block encoder 440, and the block encoder 440 further includes an inter prediction module 445, an intra prediction module 444, a residue calculator 447, a switch 448, a transform module 441, a quantization module 442 and an entropy coding module 443 coupled together as shown in FIG. 4.

In the FIG. 4 example, the partition module 431 is configured to receive image frames, and partition each image frame into blocks, such as coding blocks, coding tree blocks and the like, and provide the blocks to the block encoder 440 for encoding. In an embodiment, the partition module 431 adjusts a partition block size (e.g., horizontal partition size) based on latitude. In an example, the partition module 431 determines the partition block size based on the latitude. In another example, the control module 432 determines the partition block size, and control the partition module 431 to partition the image frames with partition block sizes adjusted based on latitudes.

The inter prediction module 445 is configured to receive a current block (e.g., a processing block), compare the block to a reference (e.g., blocks in previous frames), generate inter prediction information (e.g., description of redundant information according to inter encoding technique), and calculate inter prediction results based on the inter prediction information using any suitable technique. In the FIG. 4 example, the inter prediction module 445 includes a reference generation module 446 configured to determine a reference in a previous frame for a pixel in the current frame. In an embodiment, the reference generation module 446 is configured to calculate the reference based on a latitude of the pixel and a motion vector between the previous frame and the current flame.

The intra prediction module 444 is configured to receive the current block (e.g., a processing block), compare the block to blocks in the same picture frame, generate intra prediction information (e.g., description of redundant information according to intra encoding technique, such as using one of 35 prediction modes), and calculate prediction results based on intra prediction information.

The control module 432 is configured to determine control data and control other components of the encoder 430 based on the control data. In an embodiment, the control module 432 includes a bitrate allocation controller 433 configured to dynamically allocate bits to blocks. For example, the bitrate allocation controller 433 receives bit count information of the encoded video, adjusts a bit budget based on the bit count information, and allocates bits to blocks of input video to meet the bitrate for transmitting or displaying video in an example. The control module 432 can determine other suitable control data, such as partition size, prediction mode, quantization parameter, and the like in an example.

The residue calculator 447 is configured to calculate a difference (residue data) between the received block and prediction results selected from the intra prediction module 444 or the inter prediction module 445. The transform module 441 is configured to operate based on the residue data to generate transform coefficients. In an example, the residue data has relatively larger levels (energy) at high frequencies, and the transform module 441 is configured to convert the residue data in the frequency domain, and extract the high frequency portions for encoding to generate the transform coefficients.

The quantization module 442 is configured to quantize the transform coefficients. In an embodiment, the quantization module 442 is configured to adjust a quantization parameter based on latitude. In an example, the quantization module 442 is configured to determine the quantization parameter for a block based on the latitude of the block, and use the determined quantization parameter to quantize the transform coefficients of the block.

The entropy coding module 443 is configured to format the bit stream to include the encoded block. In an example, the entropy coding module 443 is configured to include other information such as block size, quantization parameter information, a reference calculation mode, and the like in the encoded video.

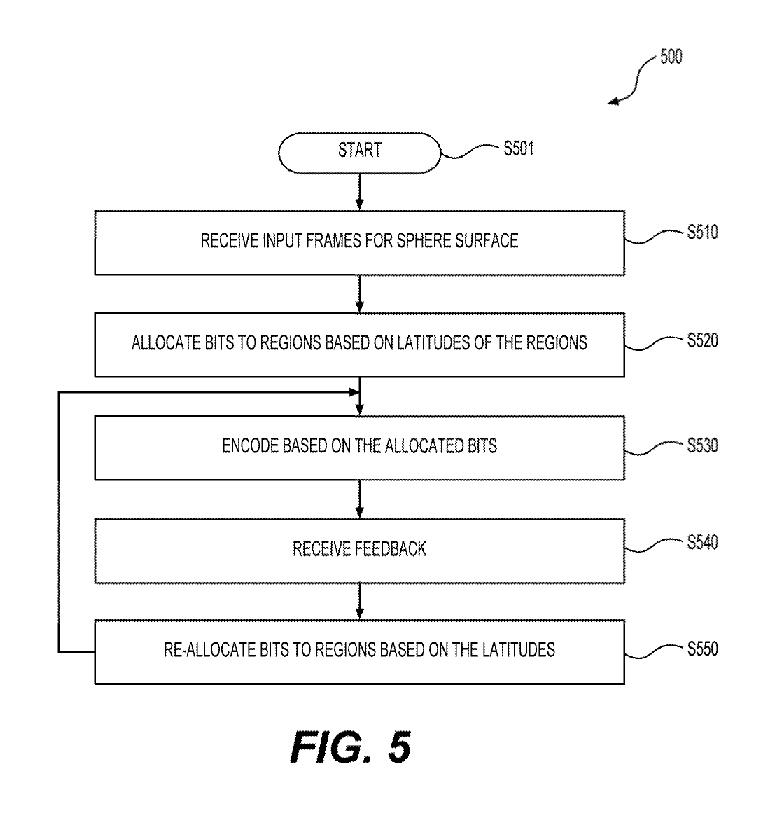

FIG. 5 shows a flow chart outlining a process example 500 according to an embodiment of the disclosure. In an example, the process 500 is executed by an encoder, such as the encoder 130, the encoder 430 and the like. The process starts at S501 and proceeds to S510.

At S510, a sequence of 2D image frames in a rectangular plane are received. The 2D images correspond to images of a sphere surface, and the images of the sphere surface are projected to the rectangular plane according to ERP projection to generate the 2D images.

At S520, bits are allocated to regions based on latitudes of the regions. In an embodiment, the bitrate allocation controller 433 determines budget bits for each image frame to meet a bitrate to transmit and play the sequence of image frames. Further, for a current image frame to encode, the bitrate allocation controller 433 allocates budget bits to regions, such as coding blocks, coding tree blocks and the like based on latitudes of the regions. For example, the bitrate allocation controller 433 allocates more bits to coding blocks that are near the vertical center of the rectangular plane (e.g., the absolute value of the latitude is relatively small), and allocates less bits to coding blocks that are away from the vertical center of the rectangular plane (e.g., the absolute value of the latitude is relatively large).

At S530, one or more coding units are encoded based on the allocated bits. In an embodiment, the block encoder 440 can use suitable coding parameters, coding techniques to encode one or more coding blocks based on the allocated bits. For example, when a relatively large number of bits are allocated to a block, the block encoder 440 can use coding parameters and coding techniques that can provide relatively high image quality; and when a relatively small number of bits are allocated to a block, the block encoder 440 can use coding parameters and coding techniques that can provide a relatively high compression ratio.

At S540, feedback information is received. In an example, the bits in the encoded video are counted, and the counted value is provided to the bitrate allocation controller 433.

At S550, bits are re-allocated based on the latitudes. In an embodiment, the bitrate allocation controller 433 receives the bit counts of encoded video, and then updates budget bits to remaining blocks and/or images for encoding. Then the process returns to S530 to encode based on the updated bit allocation.

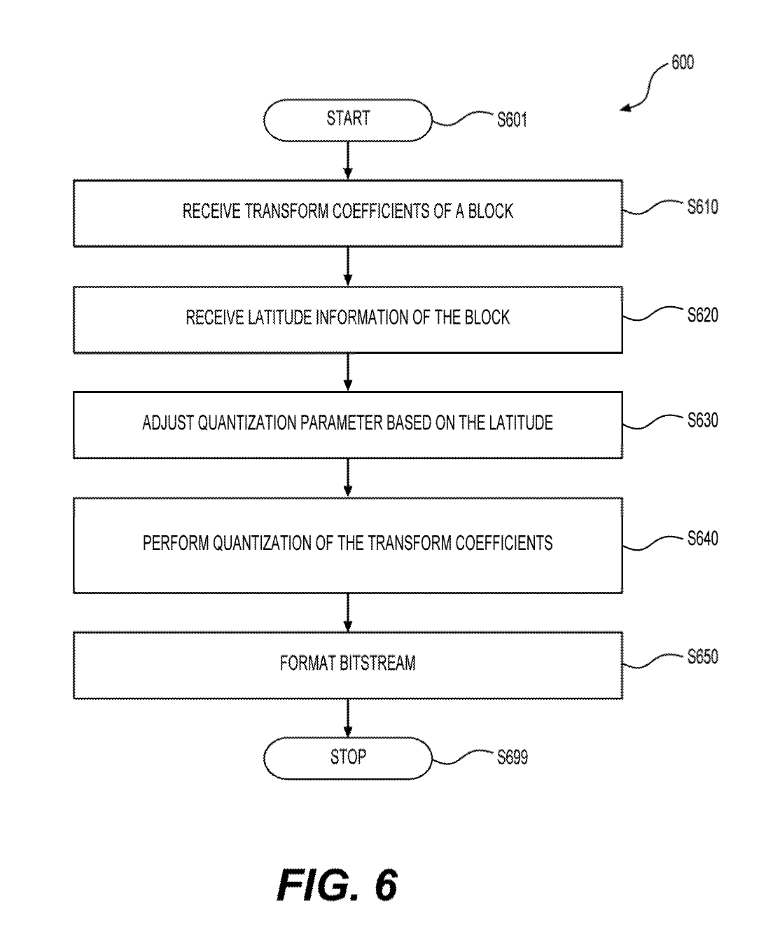

FIG. 6 shows a flow chart outlining a process example 600 according to an embodiment of the disclosure. In an example, the process 600 is executed by the quantization module 442. The process starts at S601 and proceeds to S610,

At S610, transform coefficients of a block are received. In an example, the quantization module 442 receives transform coefficients of a block from the transform module 441.

At S620, latitude information of the block is received. In an example, the quantization module 442 receives the latitude of the center of the block, for example, from the control module 432.

At S630, a quantization parameter is adjusted based on the latitude. In an example, the quantization module 442 is configured to adjust a quantization parameter based on the latitude. In an example, the quantization module 442 is configured to assign a relatively small quantization parameter to coding blocks that are near the vertical center of the rectangular plane (e.g., the absolute value of the latitude is relatively small), and assign a relatively large quantization parameter to coding blocks that are away from the vertical center of the rectangular plane (e.g., the absolute value of the latitude is relatively large).

At S640, quantization is performed based on the adjusted quantization parameter. In an example, the quantization module 442 uses the quantization parameter to determine a quantization matrix, and use the quantization matrix to quantize the transform coefficients of the block.

At S650, an output bit stream (encoded video) is generated. In an example, the entropy coding module 443 is configured to format the bit stream to include the encoded block. In an example, the entropy coding module 443 is configured to include quantization parameter information in the output bit stream. Then the process proceeds to S699 and terminates.

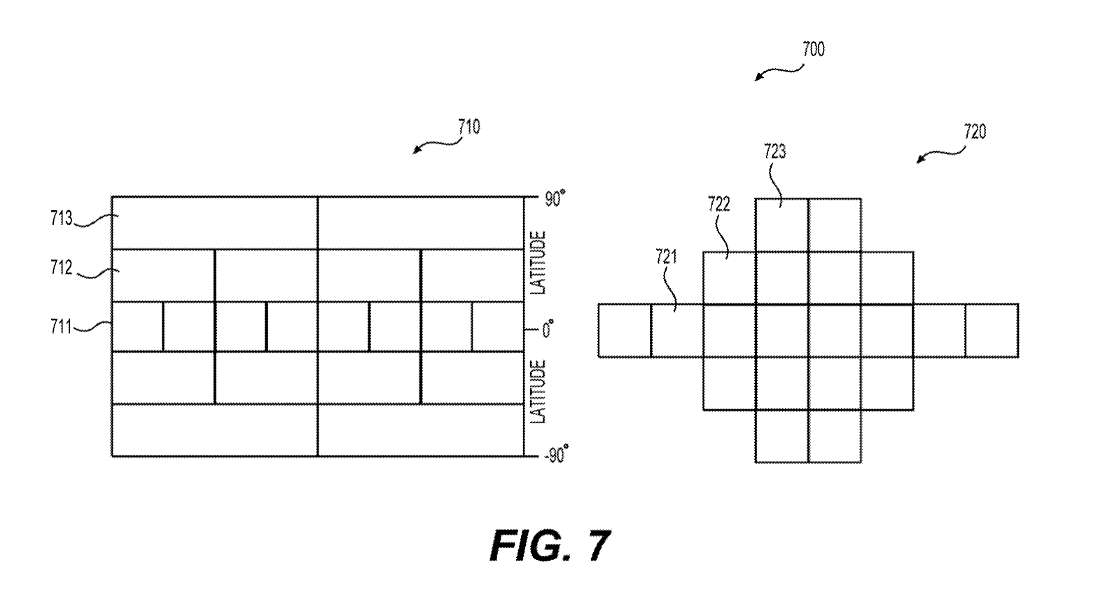

FIG. 7 shows a plot 700 of partition examples according to an embodiment of the disclosure. The plot 700 includes a first partition example 710 and a second partition example 720.

In the first partition example 710, the horizontal partition size varies by latitude. For example, coding blocks 711-713 have different latitudes and are partitioned using different horizontal partition sizes.

In the second partition example 720, the frame is down-sampled by different down-sampling rates based on latitudes. For example, rows 721, 722 and 723 are down-sampled by different down-sampling rates. In the example, the down-sampled rows 721, 722 and 723 are then partitioned using the same horizontal partition size.

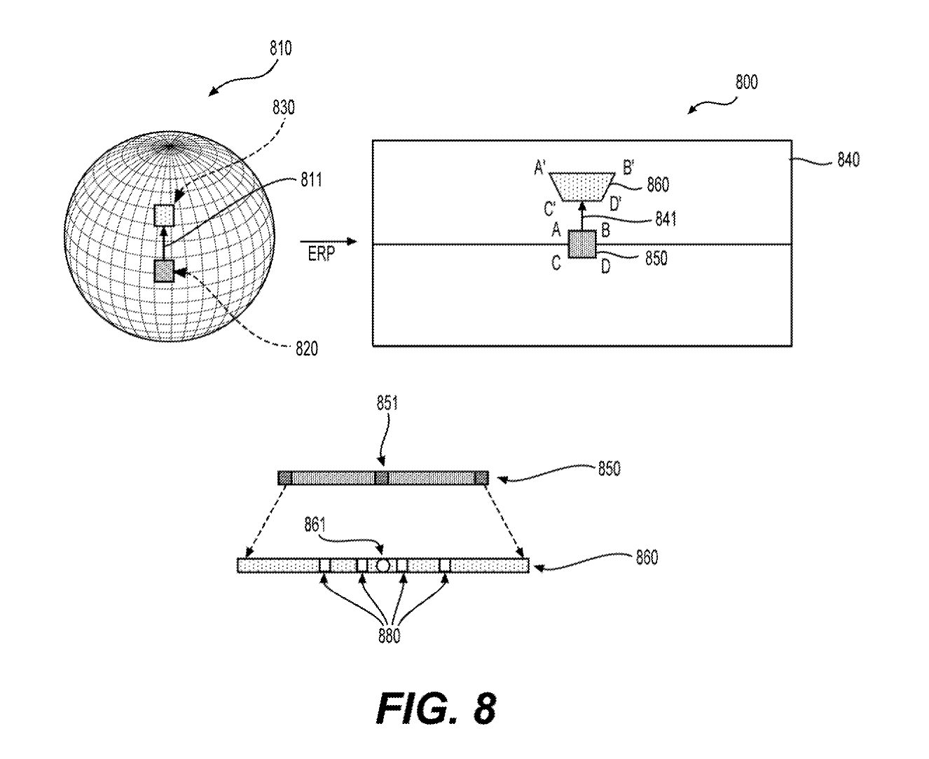

FIG. 8 shows a plot 800 illustrating a reference calculation example according to an embodiment of the disclosure. In some embodiments, projection can cause shape change (deformation) as a function of locations. During inter prediction, in an example, motion compensation is preformed using deformed reference that is calculated based on image characteristics associated with the projection, and is referred to as deformed motion compensation. FIG. 8 shows an example of deformed motion compensation for ERP projection.

In the FIG. 8 example, the plot 800 shows a sphere surface 810 for taking omni-directional images (or video). The omni-directional images can be projected to a rectangular plane 840 according to ERP projection.

In an embodiment, inter prediction is used for encoding/decoding. During inter prediction, for a current block in a present image frame, a reference block in a previous image frame is determined to predict the current block.

According to an aspect of the disclosure, due to ERP projection, the shape of the block can be deformed due to latitude difference. In the FIG. 8 example, on the sphere surface 810, for a current block 820 a reference block 830 is determined, and the current block 820 and the reference block 830 have different latitudes. In the example, the current block 820 and the reference block 830 have the same shape on the sphere surface.

In the example, the current block 820 is projected to the rectangular plane 840 as a projected current block 850 having ABCD corner points, and the reference block 830 is projected to the rectangular plane 840 as a projected reference block 860 having A′B′C′D′ corner points. Due to the latitude difference, the projected current block 850 and the projected reference block 860 have different shapes. In an example, the corner point A has coordinates (x0,y0), the corner point B has coordinates (x1,y1), the corner point C has coordinates (x2,y2), the corner point D has coordinates (x3 ,y3); the corner point A′ has coordinates (x0′,y0′), the corner point has coordinates (x1′,y1′), the corner point C has coordinates (x2′,y2′) the corner point D′ has coordinates (x3′,y3′). Further, in the example, M is the middle point between A and B and has coordinates (xm, ym), and N is the middle point between C and D and has coordinates (xn, yn′); M′ is the middle point between A′ and B′ and has coordinates (xm′, ym′) and N′ is the middle point between C′ and D′ and has coordinates (xn′, yn′); O is the middle point of the block ABCD and has coordinates (xo, yo); and O′ is the middle point of the block A′B′C′D′ and has coordinates (xo′, yo′).

Various methods can be used to determine the projected reference block based on geographical location of the projected current block and a motion vector MV (mvx, mvy).

In a first method, the motion vector MV is used to represent the displacement of point A to A′. Thus, the coordinates for the corner points A′B′C′D′ can be represented according to Eq. 1-Eq. 8.

x0′=mvx+x0 Eq. 1

y0′=mvy+y0 Eq. 2

x1′=x0′+f(y0, y0′, x1-x0) Eq. 3

y1′=y0′ Eq. 4

x2′=(x0′+x1′)/2−f(y2, y2′, x3−x1-/2 Eq. 5

y2′=mvy+y2 Eq. 6

x3′=x2′+f(y2, y2′, x3−x2) Eq. 7

y3′=y2′ Eq. 8

where f(yo, yr,L) is a function that gives how long a horizontal line with length L will be stretched into from its original latitude (yo) to reference latitude (yr) and is calculated according to Eq. 9:

$$f ( yo , y r , L ) = L * \frac{cos ( π * yo / img\_height )}{cos ( π * y r / img\_height )} \qquad Eq . 9$$

where img_height is the height of the rectangular plane 840. It is noted that the Eq. 1-8 can be suitably modified to calculate the coordinates of a reference pixel in the projected reference block for any pixel in the projected current block.

In a second method, the motion vector MV is used to represent the displacement of point M to M′. Thus, the coordinates for the points M′A′B′C′D′ can be represented according to Eq. 10-Eq. 19.

xm′=mvx+xm Eq. 10

ym′=mvy+ym Eq . 11

x0′=xm′−f(y0, y0′, x1−x0)/2 Eq. 12

y0′=ym′ Eq. 13

x1′=xm′+f(y0, y0′, x1−x0)/2 Eq. 14

y1′=ym′ Eq. 15

x2′=xm′−f(y2, y2′, x3−x2)/2 Eq. 16

y2′=mvy+y2 Eq. 17

x3′=xm′+f(y2, y2′, x3−x2)/2 Eq. 18

y3′=y2′ Eq. 19

It is noted that the Eq. 10-19 can be suitably modified to calculate the coordinates of a reference pixel in the projected reference block for any pixel in the projected current block.

In a third method, the motion vector MV is used to represent the displacement of point O to O′. Thus, the coordinates for the points O′B′C′D′ can be represented according to Eq. 20-Eq. 29.

xo′=mvx+xo Eq. 20

yo′=mvy+yo Eq. 21

x0′=xo′−f(y0, y0′, x1−x0)/2 Eq. 22

y0′=yo′−(y1−y0)/2 Eq. 23

x1′=xo′+f(y0, y0′, x1−x0)/2 Eq. 24

y1′=y0′ Eq. 25

x2′=xo′−f(y2, y2′, x3−x2)/2 Eq. 26

y2′=yo′+(y1−y0)/2 Eq. 27

x3′=xo′+f(y2, y2′, x3−x2)/2 Eq. 28

y3′=y2′ Eq. 29

It is noted that the Eq. 20-29 can be suitably modified to calculate the coordinates of a reference pixel in the projected reference block for any pixel in the projected current block.

Further, according to an aspect of the disclosure, suitable techniques, such as interpolation, down-sampling techniques, and the like are used to generate reference pixel or reference block for the current pixel or current block due to the deformation.

Further, according to an aspect of the disclosure, when the calculated coordinates do not correspond to an integer position of pixels, neighboring pixels of the calculated coordinates are selected. In the FIG. 8 example, for a point 851 in the projected current block 850, coordinates of a reference point 861 in the projected reference block 860 are calculated. The reference point 861 does not correspond to an integer position of pixels. Then neighboring pixels 880 to the reference point 861 are selected.

Further, according to an aspect of the disclosure, interpolation filters can be applied to these neighboring pixels for inter prediction. It is noted that any suitable interpolation filters can be used, such as interpolation filters according to high efficiency video coding (HEVC) standard, 6-taps Lanczos filters, bilinear interpolation filters, and the like.

According to an aspect of the disclosure, the deformed motion compensation can be used in the merge mode. Generally, the merge mode uses merge indexes that respectively indicate candidates for motion data. In an embodiment, the merge mode uses additional merge indexes to indicate the same candidates with deformed motion compensation. For example, the merge mode uses 0-4 to indicate regular motion compensation (without deformation) with the corresponding candidates, and uses 5-9 to indicate deformed motion compensation with the corresponding candidates. Thus, in an example, merge index 0 and merge index 5 indicate the same candidate but different motion compensation.

In an embodiment, deformed motion compensation is signaled and performed at various levels, such as a sequence level, a picture level, a lice level, and like. In an example, a flag for deformed motion compensation is included in a sequence parameter set (SPS) for a sequence of pictures for example by an encoder (e.g., the encoder 130, the encoder 430). When the flag indicates enabling, then block level motion compensation in the processing (encoding/decoding) of the sequence of pictures is the deformed motion compensation technique.

In another example, a flag for deformed motion compensation is included in a picture parameter set (PPS) for a picture for example by an encoder the encoder 130, the encoder 430). When the flag indicates enabling, then block level motion compensation in the processing (encoding/decoding) of the picture is the deformed motion compensation technique.

In another example, a flag for deformed motion compensation is included in a slice header of a slice among a plurality of slices for a picture for example by an encoder (e.g., the encoder 130, the encoder 430). When the flag indicates enabling, then block level motion compensation in the processing (encoding/decoding) of the slice is the deformed motion compensation technique.

In another embodiment, deformed motion compensation is selectively used at block level. In an example, an encoder, such as the encoder 130, the encoder 430, and the like selects one of regular motion compensation (without deformation) and the delimited motion compensation for each block, for example, based on a prediction quality, and uses a flag in the encoded block to indicate the selection. Then, a decoder, such as the decoder 180 and the like, can extract a flag in each block that is indicative of the selection for motion compensation, and then decode the block accordingly.

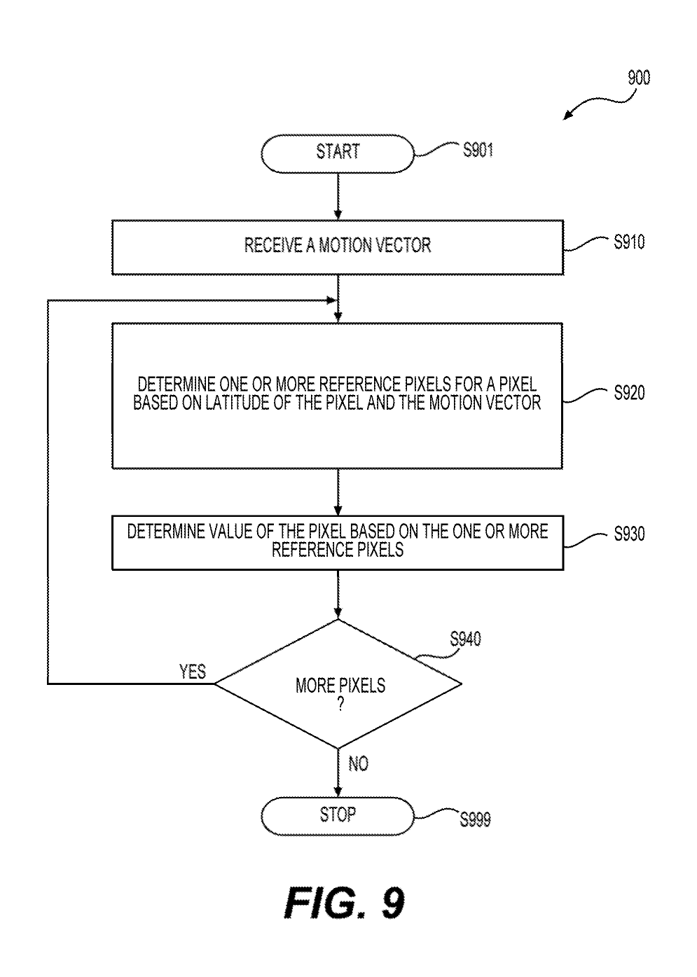

FIG. 9 shows a flow chart outlining a process example 900 according to an embodiment of the disclosure. In an example, the process 900 is executed by a coder, such as the encoder 130, the encoder 430, the decoder 180, and the like for inter prediction. In the example, images of a sphere surface are projected to a rectangular plane according to ERP projection to generate the 2D images. Due to the ERP projection, images are deformed, and the process 900 calculates reference pixels based on latitude and motion vector. The process starts at S901 and proceeds to S910.

At S910, a motion vector is received. In an example, the motion vector is indicative a movement of objects between a current frame and a previous frame.

At S920, for a pixel in the current frame, one or more reference pixels are determined based on latitude of the pixel and the motion vector. In an example, the one or more pixels are determined according to method disclosure with regard to FIG. 8.

At S930, the value of the pixel in the current frame is predicted based on the one or more reference pixels. In an example, an interpolation filter is applied to these pixels for inter prediction.

At S940, when more pixels for inter prediction exist, the process returns to S920; otherwise, the process proceeds to S999 and terminates.

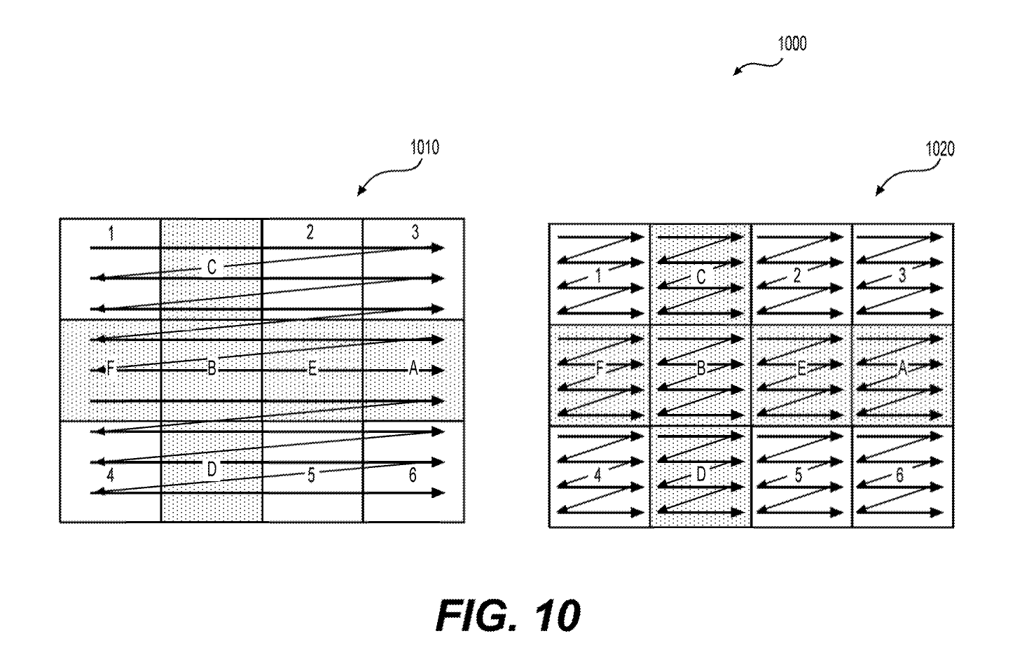

FIG. 10 shows a plot 1000 illustrating block scan examples according to an embodiment of the disclosure. The plot 1000 shows a first scan example 1010 and a second scan example 1020 for an image frame in a rectangular plane. The image frame is generated by projecting an image of a sphere surface according to a cube projection. The six faces of the cube projection are arranged as A-E, dummy Faces 1-6 are added to form the image frame in the rectangular plane.

In the first scan example 1010, blocks, such as coding blocks, coding tree blocks, and the like, are scanned using large z-patterns that are across the entire horizontal width of images.

In the second scan example 1020, blocks, such as coding blocks, coding tree blocks, and the like are scanned using small z-patterns that are across the horizontal width of each face. In an example, the second can example 1020 is used by the encoder 130.

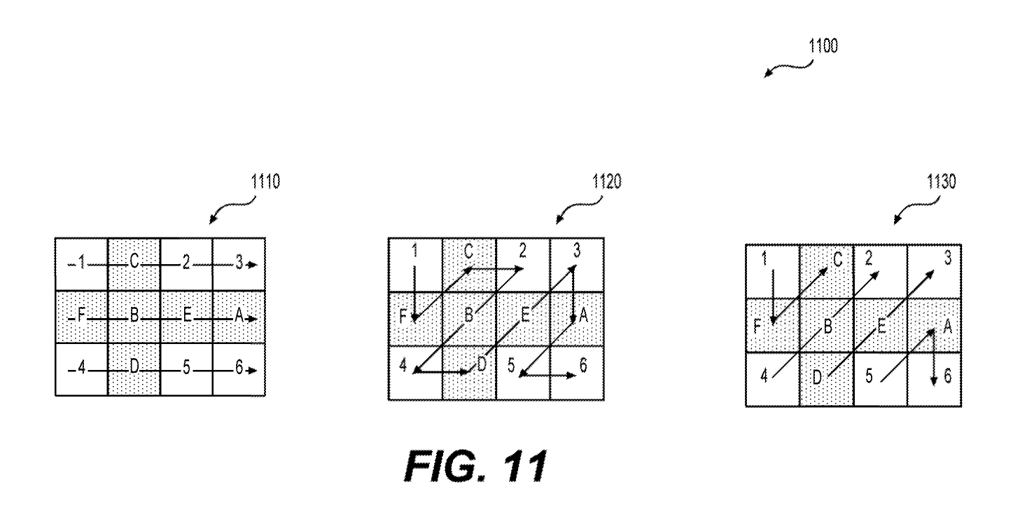

FIG. 11 shows a plot 1100 illustrating, face scan examples according to an embodiment of the disclosure. The plot 1100 shows a first scan example 1110, a second scan example 1120, and a third scan example 1130 for an image frame in a rectangular plane. The image frame is generated by projecting an image of a sphere surface according to a cube projection. The six faces of the cube projection are arranged as A-E, dummy faces 1-6 are added to form the image frame in the rectangular plane.

In the first scan example 1110, faces including the projected faces A-E and the dummy faces 1-6 are scanned row by row, such as a sequence of 1-C-2-3-F-B-E-A-4-D-5-6 as shown.

In the second scan example 1120, faces including the projected faces A-E and the dummy faces 1-6 are scanned using a specific sequence of 1-F-C-2-B-4-D-E-3-A-5-6 as shown.

In the third scan example 1130, faces including the projected faces A-E and the dummy faces 1-6 are scanned using a specific sequence of 1-F-C-4-13-2-D-E-5-A-6 as shown.

It is noted that, in another example, when the dummy faces 1-6 positions are known, the dummy faces 1-6 are skipped during scan. For example, faces A-E can be scanned in the sequence of F-C-B-D-E-A.

It is noted that the various modules and components in the present disclosure can be implemented using any suitable technology. In an example, a module can be implemented using integrated circuit (IC). In another example, a module can be implemented as a processor executing software instructions.

When one or more modules are implemented in software to be executed by a processor, the software may be transmitted over as one or more instructions or may be stored on a computer-readable medium. The computer-readable media includes both non-transitory computer storage media and communication media including any medium that facilitates transfer of a computer program from one place to another. The non-transitory computer-readable media can comprise RAM, ROM, EEPROM, CD-ROM, compact disc (CD), laser disc, optical disc, digital versatile disc (DVD), floppy disk and blu-ray disc or other optical disk storage, magnetic disk storage or other magnetic storage devices, or any other medium that can be used to store desired program codes in the form of instructions or data structures and that can be accessed by a general-purpose or special-purpose computer, or a general-purpose or special-purpose processor. Also, in an example, a communication connection is properly termed as a computer-readable medium. For example, when the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium.

When implemented in hardware, the hardware may comprise one or more of discrete components, an integrated circuit, an application-specific integrated circuit (ASIC), etc.

While aspects of the present disclosure have been described in conjunction with the specific embodiments thereof that are proposed as examples, alternatives, modifications and variations to the examples may be made. Accordingly, embodiments as set forth herein are intended to be illustrative and not limiting. There are changes that may be made without departing from the scope of the claims set forth below.

What is claimed is:

1. An apparatus, comprising:
a processing circuit configured to:
receive images in a rectangular plane that are projected from images of a sphere surface according to a projection from the sphere surface to the rectangular plane; and
encode/decode the images in the rectangular plane based on image characteristics of the rectangular plane that are associated with the projection.

2. The apparatus of claim 1, wherein the processing circuit is configured to:
adjust one or more encoding/decoding parameters as a function of location parameters of the rectangular plane.

3. The apparatus of claim 2, wherein the processing circuit is configured to:
adjust bit allocation for regions in the rectangular plane as a function of the location parameters of the regions.

4. The apparatus of claim 2, wherein the processing circuit is configured to:
adjust a partition size for regions in the rectangular plane as a function of the location parameters of the regions.

5. The apparatus of claim 2, wherein the processing circuit is configured to:
adjust a sampling rate for regions in the rectangular plane as a function of the location parameters of the regions.

6. The apparatus of claim 2, wherein the processing circuit is configured to:
adjust a quantization parameter for regions in the rectangular plane as a function of the location parameters of the regions.

7. The apparatus of claim 2, wherein the processing circuit is configured to:
deform a reference for a coding unit during an inter prediction based on a location parameters of the coding unit and a motion vector.

8. The apparatus of claim 2, wherein the location parameters of the rectangular plane correspond to latitudes of the rectangular plane.

9. The apparatus of claim 1, wherein the processing circuit is configured to:
receive the images in the rectangular plane that are projected from the images of the sphere surface according to a platonic solid projection from the sphere surface to a plurality of non-dummy faces re-arranged in the rectangular plane; and
encode/decode the images in the rectangular plane based on image characteristics of faces in the rectangular plane.

10. The apparatus of claim 1, wherein the processing circuit is configured to:
receive the images in the rectangular plane that are projected from the images of the sphere surface according to a projection that causes deformation as a function of locations; and
perform deformed motion compensation during an inter prediction.

11. The apparatus of claim 10, wherein the processing circuit is configured to:
selectively perform motion compensation without deformation and the deformed motion compensation based on a merge index in a merge mode.

12. The apparatus of claim 10, wherein the processing circuit is Configured to:
perform the deformed motion compensation at one of a sequence level, a picture level, a slice level and a block level based on a flag.

13. A method for image processing, comprising:
receiving, by a processing circuit, images in a rectangular plane that are projected from images of a sphere surface according to a projection from the sphere surface to the rectangular plane; and
encoding/decoding the images in the rectangular plane based on image characteristics of the rectangular plane that are associated with the projection.
